(19) United States
(12) Patent Application Publication
(10) Pub. No.: US 2019/0204188 A1
(43) Pub. Date: Jul. 4, 2019

(54) SAMPLING ADSORBER, HEAT DESORPTION CHAMBER DEVICE, SAMPLING APPARATUS AND ANALYZER APPARATUS

(71) Applicants: Tsinghua University, Beijing (CN); NUCTECH COMPANY LIMITED, Beijing (CN)

(72) Inventors: Qingjun ZHANG, Beijing (CN); Yuanjing LI, Beijing (CN); Zhiqiang CHEN, Beijing (CN); Ziran ZHAO, Beijing (CN); Yinong LIU, Beijing (CN); Yaohong LIU, Beijing (CN); Nan BAI, Beijing (CN); Ge LI, Beijing (CN); Qiufeng MA, Beijing (CN); Biao CAO, Beijing (CN); Weiping ZHU, Beijing (CN)

(73) Assignees: Tsinghua University, Beijing (CN); NUCTECH COMPANY LIMITED, Beijing (CN)

(21) Appl. No.: 16/232,672

(22) Filed: Dec. 26, 2018

(30) Foreign Application Priority Data
Dec. 29, 2017 (CN) 201711499133.8

(51) Int. Cl. G01N 1/22; B01D 53/10

(52) U.S. Cl. CPC G01N 1/2214; B01D 2259/40098; B01D 53/10; G01N 1/2205

(57) ABSTRACT

A sampling adsorber, a heat desorption chamber device, a sampling apparatus and an analyzer apparatus. The sampling adsorber includes an outer barrel, which includes an outer barrel first end and an outer barrel second end, and a core located in the outer barrel, the core having a core first end and a core second end, and the outer barrel first end and the core first end are located at a same side of the sampling adsorber. The core includes an adsorbent portion configured to adsorb a sample and a core body portion, the adsorbent portion connected to the core body portion. Sizes of the outer barrel and the core are formed such that a gap is provided between them to allow external gas to enter the gap through the adsorbent portion and to subsequently be discharged from a downstream portion of the gap.

This application claims the benefit of priority of Chinese Patent Application No. 201711499133.8, titled by “SAMPLING ADSORBER, HEAT DESORPTION CHAMBER DEVICE, SAMPLING APPARATUS AND ANALYZER APPARATUS”, filed with the State Intellectual Property Office of China on Dec. 29, 2017, the whole disclosure of which is incorporated herein by reference.

### TECHNICAL FIELD

Embodiments of the present disclosure relate to the analysis technical field, and particularly to a sampling adsorber, a heat desorption chamber and a sampling apparatus and an analyzer apparatus.

### BACKGROUND

In the art, there is a desire to perform sampling and measurement of a gas or solid particle material.

### SUMMARY

It is desired to further improve efficiency of a sampling method or a sampling apparatus. For example, at locations such as an airport or customhouse, it is desired to perform rapid and reliable inspection on cargo or packages to determine whether a contraband good is contained therein or not.

In addition, when an inspection apparatus in the art is operated to inspect a package, it is often needed to open a package or even damage part of the cargo or package so as to perform inspection, which is not really convenient for operation. It is desirable that an inspection is performed without breaking/opening the package or damaging the cargo or package.

Thus, there is desired an apparatus to rapidly and reliably sample a sample to achieve a rapid and accurate field inspection.

According to an aspect of the present disclosure, there is provided a sampling adsorber including: an outer barrel, which includes an outer barrel first end and an outer barrel second end, and a core located in the outer barrel, the core having a core first end and a core second end, the outer barrel first end and the core first end being located at a same side of the sampling adsorber, wherein the core includes an adsorbent portion configured to adsorb a sample and a core body portion, the adsorbent portion connected to the core body portion, wherein sizes of the outer barrel and the core are formed such that a gap is provided between the outer barrel and the core to allow external gas (e.g. air) to enter the gap through the adsorbent portion and to subsequently be discharged from a downstream portion of the gap.

In an embodiment, the outer barrel includes a bypass passage including a bypass passage inlet and a bypass passage outlet that are separated from each other spatially, the bypass passage inlet being closer to the outer barrel first end than the bypass passage outlet; and the sampling adsorber further includes an adsorber first inner sealing ring and an adsorber second inner sealing ring that are located between the core and the outer barrel and fixed on an outer peripheral (e.g., circumferential) surface of the core, the adsorber first inner sealing ring and the adsorber second inner sealing ring spaced apart from each other and configured to allow the core to move within the outer barrel while keeping a seal between the core and the outer barrel, and arranged such that, in a first state of the sampling adsorber, the adsorber first inner sealing ring and the adsorber second inner sealing ring are located between the bypass passage inlet and the bypass passage outlet, the adsorber first inner sealing ring is close to the bypass passage inlet and the adsorber second inner sealing ring is close to the bypass passage outlet, so that gas entering the gap through the adsorbent portion is blocked by the adsorber first inner sealing ring and flows into the bypass passage inlet, out of the bypass passage outlet and enters the downstream portion of the gap.

In an embodiment, the sampling adsorber is brought into a second state by movement of the core relative to the outer barrel, and in the second state of the sampling adsorber, the adsorber first inner sealing ring is located between the bypass passage inlet and the bypass passage outlet and the adsorber second inner sealing ring is located at a side of the bypass passage outlet away from the outer barrel first end, such that gas flowing out of the bypass passage outlet is blocked by the adsorber second inner sealing ring from entering the downstream portion of the gap.

In an embodiment, the outer barrel includes a desorbed sample passage that is configured to allow gas to flow from the adsorbent portion to outside of the outer barrel; and the sampling adsorber further includes an adsorber first inner sealing ring and an adsorber second inner sealing ring that are located between the core and the outer barrel and fixed on an outer peripheral surface of the core, the adsorber first inner sealing ring and the adsorber second inner sealing ring spaced apart from each other and configured to allow the core to move within the outer barrel while keeping a seal between the core and the outer barrel, and arranged such that, in a first state of the sampling adsorber, the inlet of the desorbed sample passage is located between the adsorber first inner sealing ring and the adsorber second inner sealing ring and gas is blocked by the adsorber first inner sealing ring and the adsorber second inner sealing ring from entering the desorbed sample passage.

In an embodiment, the sampling adsorber is brought into the second state by movement of the core relative to the outer barrel, in which second state the adsorber first inner sealing ring and the adsorber second inner sealing ring are located at a side of the inlet of the desorbed sample passage away from the outer barrel first end, such that gas enters the desorbed sample passage only through the gap and is discharged from the outer barrel through the desorbed sample passage.

In an embodiment, the core body portion includes an adsorber sampling passage having an inlet in communication with the gap and an outlet exposed to outside of the outer barrel.

In an embodiment, the sampling adsorber further includes an adsorber third sealing ring fixed on an outer peripheral surface of the core first end, the adsorber third sealing ring configured to allow the adsorber to move relative to the outer barrel while keeping a seal between the adsorber and the outer barrel.

In an embodiment, the sampling adsorber further includes a sampling head removably mounted to an end of the outer barrel, the sampling head configured to scrape an object to be inspected such that the sample is released from the object to be inspected.

In an embodiment, the sampling head is made of silicon rubber so as to adhere the sample to be inspected; and/or the sampling head has an adsorbent therein so as to adsorb the sample to be inspected.

In an embodiment, the adsorbent portion has screen mesh structures at both ends thereof to filter large size particles and the screen mesh structures are removably coupled with the adsorbent portion so as to fix an adsorbent in the adsorbent portion.

In an embodiment, the core body portion second end of the core body portion opposite to the core body portion first end includes sampling adsorber T-shaped head at its outer surface, and the outer barrel includes a sliding groove on an inner side of the outer barrel second end such that the sampling adsorber T-shaped head is slidable in the sliding groove and a movement travel of the sampling adsorber T-shaped head is defined by the sliding groove, and in the first state of the sampling adsorber, the sampling adsorber T-shaped head contacts a first end of the sliding groove, and in the second state of the sampling adsorber, the sampling adsorber T-shaped head contacts a second end of the sliding groove, the second end of the sliding groove being closer to the core body portion second end than the first end of the sliding groove.

According to an aspect of the present disclosure, there is provided a heat desorption chamber device including a chamber body, the chamber body defining a heat desorption chamber, wherein the chamber body has a chamber first end and a chamber second end that is opposite to the chamber first end and is open, and the chamber body includes a heat chamber and a cool chamber that are connected to each other by a thermal isolating disc, wherein the sampling adsorber as described herein is insertable into the cool chamber of the chamber body through the chamber second end, which is open, of the chamber body of the heat desorption chamber device.

In an embodiment, the heat desorption chamber device further includes a baffle plate and a baffle plate sealing ring between the baffle plate and the chamber, the baffle plate sealing ring configured to allow the baffle plate to be movable within the heat chamber of the heat desorption chamber while keeping a seal between the baffle plate and the chamber.

In an embodiment, the chamber body includes a carrier gas inlet and a carrier gas outlet such that, in a state of the heat desorption chamber device, the baffle plate is located at a side of the carrier gas outlet away from the chamber first end, and that a carrier gas is allowed to enter the heat desorption chamber through the carrier gas inlet and is discharged from the carrier gas outlet.

In an embodiment, the baffle plate is connected to the chamber first end of the chamber by a spring, wherein the spring is configured such that the baffle plate is kept by the spring, under no external force, at a side of the carrier gas outlet away from the chamber first end and is allowed to move towards the chamber first end by pressing the spring under an external force, so that the baffle plate sealing ring is located at a side of the carrier gas inlet close to the chamber first end.

In an embodiment, the heat desorption chamber device further includes a heating rod which is mounted to the baffle plate and protrudes from the baffle plate towards the chamber second end.

In an embodiment, the heat chamber includes: a temperature control device which includes a heater configured to heat the heat chamber and a temperature sensor configured to measure a temperature within the heat chamber; and a heat insulation portion configured to isolate heat within the heat chamber from dissipating to outside of the heat desorption chamber device.

According to an aspect of the present disclosure, there is provided a sampling apparatus including the sampling adsorber as described herein and the heat desorption chamber device as described above, wherein the sampling adsorber is insertable into the cool chamber of the heat desorption chamber device through the chamber second end, which is open, of the chamber body of the heat desorption chamber device, such that the outer barrel first end of the outer barrel of the sampling adsorber abuts against the thermal isolating disc by means of the outer barrel first sealing ring on an outer peripheral surface of the outer barrel first end.

In an embodiment, in a state where the sampling adsorber is inserted into the cool chamber of the heat desorption chamber device, the heating rod of the heat desorption chamber device contacts and applies force onto the adsorbent portion of the sampling adsorber, such that the adsorbent portion moves within the outer barrel until a sampling adsorber T-shaped head is stopped by the second end of a sliding groove.

In an embodiment, the sampling adsorber is insertable into the heat chamber of the heat desorption chamber device, such that the adsorbent portion of the sampling adsorber applies force onto heating rod to move the heating rod together with the baffle plate towards the chamber first end of the chamber body of the heat desorption chamber device until reaching the a state of the heat desorption chamber device, wherein the outer barrel first sealing ring on the outer peripheral surface of the outer barrel first end slides within the heat chamber along an inner wall of the heat chamber up to a position between the carrier gas inlet and the carrier gas outlet.

In an embodiment, a stop piece is provided on an outer peripheral surface of the outer barrel, and the stop piece is configured to, under a state of the heat desorption chamber device, abut against the thermal isolating disc of the heat desorption chamber device so as to stop the outer barrel of the sampling adsorber from moving towards the first end of the heat desorption chamber device.

In an embodiment, the sampling adsorber includes a slidable collar surrounding the outer peripheral surface of the outer barrel, the slidable collar fittable in a notch in the second end of the chamber of the heat desorption chamber device while allowing the outer barrel to move within the heat desorption chamber device.

### BRIEF DESCRIPTION OF THE DRAWINGS

Exemplary embodiments of the present disclosure will be described as examples with reference to the accompanying drawings, in which:

FIG. 1 illustrates a cross section view of a sampling adsorber according to an embodiment of the present disclosure;

FIG. 2 illustrates a cross section view of a sampling adsorber according to an embodiment of the present disclosure;

FIG. 3 illustrates a cross section view of a heat desorption chamber device according to an embodiment of the present disclosure;

FIG. 4 illustrates a cross section view of a configuration, in which the sampling adsorber is placed in the heat desorption chamber device, according to an embodiment of the present disclosure, where the sampling adsorber is not under a sample desorption state; and

FIG. 5 illustrates a cross section view of a configuration, in which the sampling adsorber is placed in the heat desorption chamber device, according to an embodiment of the present disclosure, where the sampling adsorber is under the sample desorption state.

### DETAILED DESCRIPTION OF EXEMPLARY EMBODIMENTS

A clear and complete description of technical schemes of embodiments of the present disclosure will be made by reference to the drawings. Obviously, the embodiments that are described herein merely relate to some, not all, of the embodiments of the present disclosure. Based on the disclosed embodiment herein, all of other embodiments that are obtained by those skilled in the art without inventive labor belong to protective scope of the present disclosure.

In the present disclosure, terms such as “first”, “second” are merely used for description, instead of meaning or indicating relative importance or number of a feature. As such, a feature that is defined by “first” or “second” may impliedly include one or more of the feature. In the present disclosure, “a plurality of” means two or more unless a different description is made. In this description, orientation terms such as “left side”, “right side” are described with reference to the drawings, and are not intended to be limitative to the present disclosure.

Hereinafter, a plurality of embodiments of the present disclosure will be described by reference to the drawings.

Referring to FIG. 1, an embodiment of the present disclosure provides a sampling adsorber, including an outer barrel, which includes an outer barrel first end and an outer barrel second end, and a core located in the outer barrel, the core having a core first end and a core second end and the outer barrel first end and the core first end are located at the same side of the sampling adsorber. In the embodiment, the core includes an adsorbent portion configured to adsorb a sample and a core body portion, and the adsorbent portion is connected to the core body portion and sizes of the outer barrel and the core are formed such that a gap is formed between the outer barrel and the core such that external gas (e.g., air) can enter the gap through the adsorbent portion and subsequently be discharged from a downstream part of the gap.

As shown in FIG. 1, generally, the sampling adsorber includes an outer barrel 1001 and a core 1002 located in the outer barrel 1001. The core 1002 includes an adsorbent portion 102 and a core body portion. In FIG. 1, the core body portion may be considered as a remaining portion of the core 1002 excluding the adsorbent portion 102. It is noted that the embodiment shown in FIG. 1 is an example of the present disclosure, in which a size of the adsorbent portion is substantially similar to that of the core body portion. However, in an embodiment of the present disclosure, the adsorbent portion and the core body portion may have different sizes. For example, in an embodiment, a size of the adsorbent portion may be less than that of the core body portion. In an embodiment, a size of the adsorbent portion may be greater than that of the core body portion. In an embodiment, the adsorbent portion and the core body portion may have a shape of a cylinder. In an embodiment, the adsorbent portion and the core body portion may have a shape of a cylinder that has an elliptic section. In an embodiment, the adsorbent portion and the core body portion may have a shape of a cylinder that has a substantially elliptic section.

In FIG. 1, an outer barrel first end of the outer barrel 1001 and a core first end of the core 1002 are located a left side and an outer barrel second end of the outer barrel 1001 and a core second end of the adsorbent core 1002 are located a right side of FIG. 1. A gap is defined between the outer barrel 1001 and the adsorbent core 1002. External gas (e.g., air) may flow from the left side to the right side of FIG. 1, that is, the external gas firstly enters the sampling adsorber through the adsorbent portion 102, and then enters the gap. The gap in FIG. 1 is located between the outer barrel 1001 and the adsorbent portion 102 and includes a gap portion at an upper side of the adsorbent portion 102 and a gap portion at a lower side of the adsorbent portion 102. In practice, the gap may be a gap surrounding the adsorbent portion 102. The downstream portion of the gap is at right side of FIG. 1.

In an embodiment, the outer barrel 1001 includes a bypass passage 104 including a bypass passage inlet 1041 and a bypass passage outlet 1042 that are separated from each other spatially. The bypass passage inlet 1041 is closer to the outer barrel first end than the bypass passage outlet 1042. The sampling adsorber further includes an adsorber first inner sealing ring 1031 and an adsorber second inner sealing ring 1032 that are located between the core 1002 and the outer barrel 1001 and fixed on an outer peripheral (e.g., circumferential) surface of the core 1002. The adsorber first inner sealing ring 1031 and the adsorber second inner sealing ring 1032 are spaced apart from each other and are configured to allow the core 1002 to move within the outer barrel 1001 while keeping a seal between the core 1002 and the outer barrel 1001, and are configured such that, in a first state of the sampling adsorber, the adsorber first inner sealing ring 1031 and the adsorber second inner sealing ring 1032 are located between the bypass passage inlet 1041 and the bypass passage outlet 1042, the adsorber first inner sealing ring 1031 is close to the bypass passage inlet 1041 and the adsorber second inner sealing ring 1032 is close to the bypass passage outlet 1042, so that the gas entering the gap through the adsorbent portion 102 is blocked by the adsorber first inner sealing ring 1031, flows into the bypass passage inlet 1041, flows out of the bypass passage outlet 1042 and enters the downstream portion of the gap.

The first state of the sampling adsorber may be considered as a sampling and adsorbing state, that is, when the gas containing a sample to be sampled passes through the adsorbent portion 102, the sample is adsorbed by the adsorbent portion while the gas enters the gap through the adsorbent portion 102 and is finally discharged.

In order to increase the efficiency of sampling and adsorption, a pump 201 may be provided at a downstream portion of the gap to establish suction action in the gap, promoting entering and passing of the gas through the adsorbent portion 102.

In an embodiment, the core body portion includes an adsorber sampling passage 108, wherein an inlet of the adsorber sampling passage 108 is communicatively coupled with the gap and an outlet thereof is exposed to outside of the outer barrel 1001. Provision of the adsorber sampling passage 108 is in favor of collecting the gas that has passed through the sampling adsorber. For example, when the pump 201 is used, it may be communicatively coupled with the outlet of the adsorber sampling passage 108 to pump and suck the gas. However, it is not necessary to provide the adsorber sampling passage 108 in other embodiments.

In an embodiment in which the adsorber sampling passage 108 is provided, a sealing ring 1034 is provided at the downstream portion of the inlet of the adsorber sampling passage 108, for blocking gas.

In an embodiment, the sampling adsorber is brought into a second state by movement of the core 1002 relative to the outer barrel 1001. In the second state of the sampling adsorber, the adsorber first inner sealing ring 1031 is located between the bypass passage inlet 1041 and the bypass passage outlet 1042 and the adsorber second inner sealing ring 1032 is located at a side of the bypass passage outlet 1042 away from the outer barrel first end, such that gas out of the bypass passage outlet 1042 is blocked by the adsorber second inner sealing ring 1032 and cannot enter a downstream portion of the gap. Referring to the sampling adsorber in FIG. 4, it can be seen that the adsorber first inner sealing ring 1031 is located between the bypass passage inlet 1041 and the bypass passage outlet 1042 and the adsorber second inner sealing ring 1032 is located at the right side of the bypass passage outlet 1042, such that gas out of the bypass passage outlet 1042 is blocked by the adsorber second inner sealing ring 1032, thereby substantially sealing the bypass passage 104. In this configuration, the gas entering the gap cannot flow to a downstream portion of the gap, that is, cannot be vented from the right side of the gap.

In an embodiment, the outer barrel 1001 includes a desorbed sample passage 110 that allows the gas to flow from the adsorbent portion 102 to outside of the outer barrel 1001. As shown in FIG. 1, the desorbed sample passage 110 may be disposed at a lower side of the outer barrel 1001, or at another location of the outer barrel 1001 different from the location of the bypass passage 104. During sampling and adsorbing operation of the adsorber, the desorbed sample passage 110 is blocked, that is, the inlet of the desorbed sample passage 110 is located between the adsorber first inner sealing ring 1031 and the adsorber second inner sealing ring 1032, such that gas that has passed through the adsorbent portion 102 is blocked by the adsorber first inner sealing ring 1031 and the adsorber second inner sealing ring 1032 and cannot enter the desorbed sample passage 110. In FIG. 1, the inlet of the desorbed sample passage 110 is located at a right side of the adsorber first inner sealing ring 1031 and thus the gas in the left portion of the gap is blocked by the adsorber first inner sealing ring 1031.

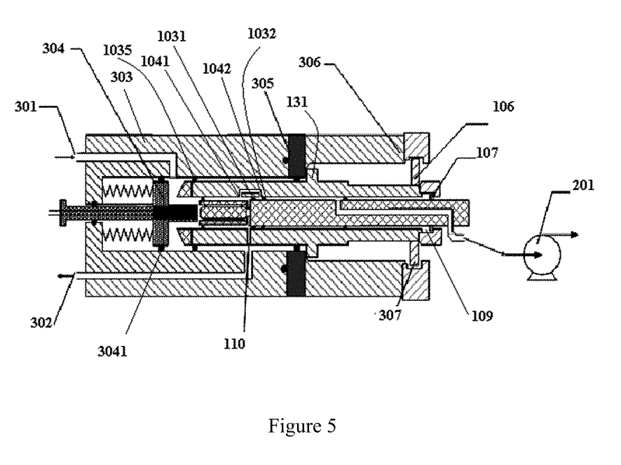

In an embodiment, the sampling adsorber is brought to the second state by movement of the core 1002 relative to the outer barrel 1001. As for the sampling adsorber shown in FIG. 4 and FIG. 5, the adsorber first inner sealing ring 1031 and the adsorber second inner sealing ring 1032 are located at a side of the inlet of the desorbed sample passage 110 away from the first end of the outer barrel 1001, such that the gas can only enter the desorbed sample passage 110 through the gap and is discharged from the outer barrel 1001 through the desorbed sample passage 110.

The second state of the sampling adsorber may be considered as a desorption state, that is, the sample adsorbed by the adsorbent portion 102 is desorbed from the adsorbent portion 102 and is discharged from the sampling adsorber through the desorbed sample passage 110. Under the second state of the sampling adsorber, the adsorber second inner sealing ring 1032 is located at a right side of the bypass passage outlet 1042 such that the gas from the bypass passage outlet 1042 is blocked by the adsorber second inner sealing ring 1032, and meanwhile, the adsorber first inner sealing ring 1031 and the adsorber second inner sealing ring 1032 are located at a right side of the inlet of the desorbed sample passage 110, allowing the gas to enter the desorbed sample passage 110 through the inlet of the desorbed sample passage 110 and be discharged from the sampling adsorber. In brief, in this state, the sample cannot be passed to the right side of FIG. 4 or FIG. 5 through the gap and can only be discharged from the sampling adsorber through the desorbed sample passage 110, to be collected by an analytical apparatus for analysis. According to the present disclosure, with the above configuration, the sampling adsorber may provide switching between the sampling and adsorbing state and the desorption state through simple movement of the core 1002 and thus achieve a simple and stable operation.

In the above embodiments, it is not necessary to set the positions of the bypass passage inlet 1041 and the bypass passage outlet 1042 at the outer barrel 1001 (along a length direction of the outer barrel 1001) and a position of the inlet of the desorbed sample passage 110 (along the length direction of the outer barrel 1001) as those shown in FIG. 1, and it is also not necessary to set a distance between the bypass passage inlet 1041 and the bypass passage outlet 1042 as the distance as shown in FIG. 1, as long as they are set such that the first state and the second state of the sampling adsorber can be achieved.

For example, as shown in FIG. 1, under the first state, an interface between the adsorbent portion 102 and the core body portion is aligned with the bypass passage inlet 1041. However, this is not necessary. The embodiment as shown in FIG. 1 is merely one of the optional structures of the sampling adsorber according to the disclosure.

In an embodiment, the core body portion includes a core body portion second end, i.e., an end of the core body portion at the right side in FIG. 1. The core body portion second end includes a sampling adsorber T-shaped head 107 at its outer surface. Accordingly, the outer barrel 1001 includes a sliding groove 109 inside of the outer barrel second end. The sampling adsorber T-shaped head 107 is configured to slide in the sliding groove 109 and a movement travel of the sampling adsorber T-shaped head 107 is defined by the sliding groove 109. That is, the sampling adsorber T-shaped head 107 can move to a left end of the sliding groove 109 to a leftmost extent and move to a right end of the sliding groove 109 to a rightmost extent, that is, the sampling adsorber T-shaped head 107 can move between the left end and the right end of the sliding groove 109. Accordingly, when sampling adsorber T-shaped head 107 abuts against the left end of the sliding groove 109, the sampling adsorber is in the first state; when the sampling adsorber T-shaped head 107 abuts against the right end of the sliding groove 109, the sampling adsorber is in the second state.

With the above configuration of matching between the sampling adsorber T-shaped head 107 and the sliding groove 109, the sampling adsorber may be brought to the first state by simple operation such as by pushing the core 1002 towards the left side such that the sampling adsorber T-shaped head 107 abuts against the left end of the sliding groove 109, and may be brought to the second state by pushing the core 1002 towards the right side such that the sampling adsorber T-shaped head 107 abuts against the right end of the sliding groove 109, thereby improving convenience and stability of operation of the sampling adsorber.

In an embodiment, the sampling adsorber further includes a sampling head 101 removably mounted to an end of the outer barrel 1001. The sampling head 101 is configured to scrape an object to be inspected such that the sample may be separated from the object to be inspected. The sampling head 101 may be connected to a left end of the outer barrel 1001 by a screw thread. The sampling head 101 may be made of silicon rubber material such that it may be attached to the left end of the outer barrel 1001 by an adhesion strap.

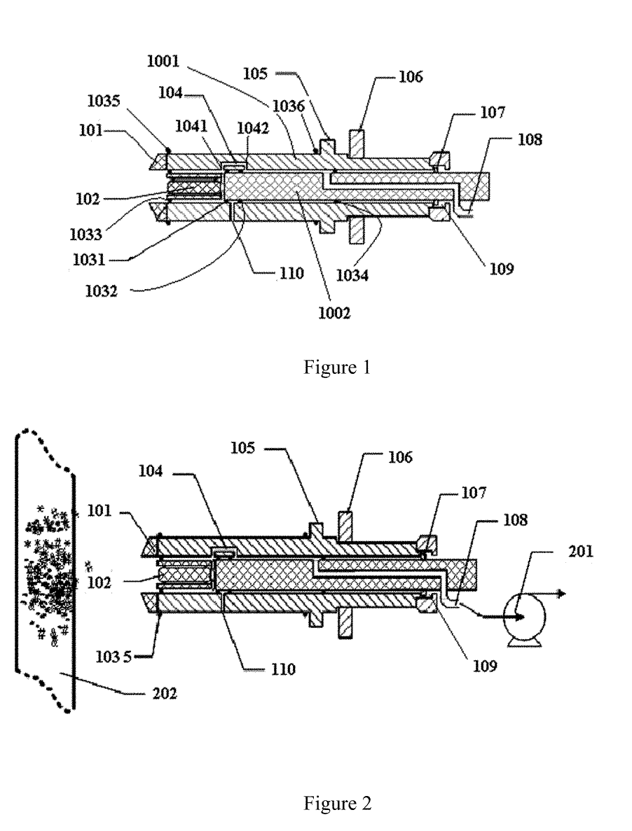

As shown in FIG. 2, the sampling adsorber is brought to close to surface of an object 202 to be inspected and the sampling head 101 is made to contact and scrape the surface of the object to be inspected. A sample that is disjunctive is scraped from the object to be inspected and then enters the adsorbent portion 102 so as to be adsorbed by the adsorbent portion 102. The sampling head 101 may be made of silicon rubber such that the sample can be cohered to the sampling head 101. In an embodiment, the sampling head 101 may be provided with an adsorbing agent such that the sampling head 101 may adsorb the sample.

It is an advantage to provide the sampling head 101 in that during sampling, the sampling head 101 of, e.g., silicon rubber, as a leading end of the sampling adsorber, may scrape a human body or object to be inspected while a suction action may be performed by operating a pump 201 so as to adsorb the sample from the human body or object to be inspected, and the adsorbed sample may be condensed by an extending sampling time period.

In an embodiment, the adsorbent portion 102 may be provided with screen mesh structures at both ends thereof and the screen mesh structures are removably coupled with the adsorbent portion 102 so as to fix the adsorbent in the adsorbent portion 102. For example, the screen mesh structure is matched with the adsorbent portion 102 by screw thread. This configuration not only allows the screen mesh structures to be removed so as to conveniently replace adsorbent within the adsorbent portion 102 but also allows the gas to pass through the adsorbent portion 102 while avoiding contamination by blocking powder and dust including large particles outside of the adsorbent portion 102 during sampling.

In an embodiment, the sampling adsorber further includes an adsorber third sealing ring 1033 fixed on an outer peripheral surface of the core first end. The adsorber third sealing ring 1033 is configured to allow the adsorber 102 to move relative to the outer barrel 1001 while keeping a seal between the adsorber 102 and the outer barrel 1001. It is an advantage to provide the adsorber third sealing ring 1033 in that the gas is blocked by the adsorber third sealing ring 1033 and thus enters the sampling adsorber through the adsorbent portion 102, instead of entering the sampling adsorber through the gap between the outer barrel 1001 and the core 1002.

In practice, it is an advantage to provide the pump 201. For example, as shown in FIG. 2, the pump 201 is connected to the outlet of the core body portion sampling passage 108 by a bellows. The sampling adsorber as shown in FIG. 2 is in the first state (sampling and adsorbing state), wherein the bypass passage 104 is in a conducting state or on-state and the suction action of the pump 201 generates a negative pressure in the gap such that gas at the left side of the sampling adsorber is sucked into the sampling adsorber. The gas firstly is sucked into the adsorbent portion 102 and thus the sample contained in the gas is adsorbed by the adsorbent portion 102. Then the gas enters the downstream portion of the gap via the bypass passage 104 and subsequently enters the core body portion sampling passage 108 and pumped away by the pump 201.

Embodiments of the present disclosure further provide a heat desorption chamber device including a chamber body. The chamber body defines a heat desorption chamber. The chamber body has a chamber first end and a chamber second end that is opposite to the chamber first end and is open. The heat desorption chamber device further includes a baffle plate 304 and a baffle plate sealing ring 3041 disposed between the baffle plate 304 and the chamber body. The baffle plate sealing ring 3041 is configured to allow the baffle plate 304 to move in the heat desorption chamber while keeping a seal between the baffle plate 304 and the chamber body. The chamber body includes a carrier gas inlet 301 and a carrier gas outlet 302 such that, when the heat desorption chamber device is in a third state, the baffle plate 304 is located at a side of the carrier gas outlet 302 away from the chamber first end and the carrier gas may enter the heat desorption chamber from the carrier gas inlet 301 and is discharged through the carrier gas outlet 302.

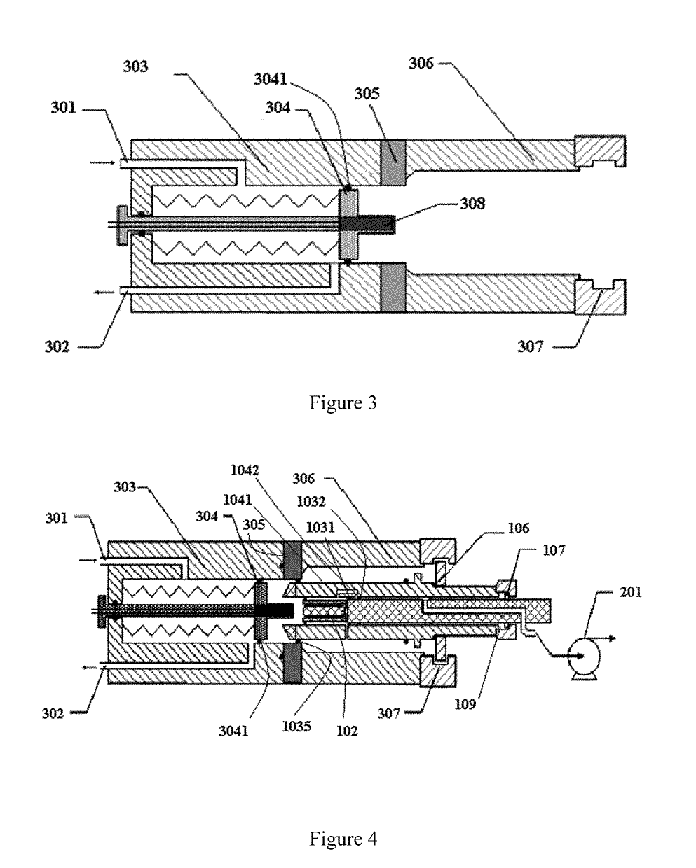

As shown in FIG. 3, the heat desorption chamber device is constituted by a chamber body and the chamber body defines an inner space, i.e., the heat desorption chamber. Herein, the chamber first end is a left end of the chamber body and the chamber second end is a right end of the chamber body. As shown in FIG. 3, the right end of the chamber body is open and the heat desorption chamber may be accessed through the right end of the chamber body.

The heat desorption chamber device further includes a baffle plate 304 within the chamber body. The baffle plate 304 may slide along a length direction of the chamber body, that is, the baffle plate 304 may move left and right as shown in FIG. 3. A baffle plate sealing ring 3041 is provided between the baffle plate 304 and an inner wall of the chamber body such that the gas at the left side of the baffle plate 304 cannot reach the right side of the baffle plate.

In an embodiment, the baffle plate 304 is connected to the chamber first end of the chamber body by a spring, thus the baffle plate 304 is kept at a side of the carrier gas outlet 302 away from the chamber first end by the spring when no external force is applied, and is allowed to move towards the chamber first end by pressing the spring under an external force, such that the baffle plate sealing ring 3041 is brought to and located at a side of the carrier gas inlet 301 close to the chamber first end. In FIG. 3, a left side of the baffle plate 304 is supported by the spring such that the baffle plate 304 is maintained to be stable. With this configuration, the baffle plate 304 makes no movement under no external force, and if the baffle plate 304 is compressed, the baffle plate 304 will be pushed back by the spring to its initial position upon the external force being withdrawn, thereby achieving a convenient operation. In other words, in practice, a user may use the device by inserting an external apparatus and pull out the external apparatus after use, without adjusting or operating the baffle plate 304 or other components, which results in a simple operation.

In an example, the heat desorption chamber device is further provided with a guide rod. The guide rod is coupled to the baffle plate 304, particularly, coupled to a left side of the baffle plate 304. The guide rod may be a telescopic or retractable, that is, the guide rod itself may be retractable so as to allow the baffle plate 304 to move leftwards. When the baffle plate 304 move to right side, the guide rod extends such that the guide rod may stabilize the movement of the baffle plate 304. In the embodiment as shown in FIG. 3, the guide rod may be not retractable. The guide rod penetrates through the left end of the chamber body of the heat desorption chamber device and may reciprocate in an aperture in the left end of the chamber body such that the baffle plate 304 may move left and right. A guide rod sealing ring is provided between the guide rod and a wall of the aperture in the left end of the chamber body to block communication of the gas between inside and outside of the chamber body. However, it is noted that the guide rod is not indispensable in the present disclosure, that is, in other embodiments of the present disclosure, the baffle plate 304 may move left and right within the chamber body without any guide rod.

In an embodiment, the heat desorption chamber device includes a heating rod 308 which is mounted to the baffle plate 304 and protrudes from the baffle plate 304 towards the chamber second end. As shown in FIG. 3, the heating rod 308 is disposed at the right side of the baffle plate 304.

The chamber body of the heat desorption chamber device as shown in FIG. 3 may include a heat chamber 303 and a cool chamber 306. The heat chamber 303 is connected to the cool chamber 306 by a thermal isolating disc 305. The thermal isolating disc 305 may isolate heat between the cool chamber 306 and the heat chamber 303 so to prevent heat from exchanging between the chambers. The baffle plate 304 moves within the heat chamber 303. In other words, the movement range of the baffle plate 304 may be defined by the thermal isolating disc 305, that is, the baffle plate 304 does not move to the right side of the thermal isolating disc 305 when no external force is provided.

It is an advantage to provide the heat chamber 303 and the cool chamber 306. On the one hand, the cool chamber 306 may be provided to help ensure the sample adsorbed by the sampling adsorber will not be heated and desorbed from the sampling adsorber before the sampling adsorber is pushed into the heat chamber 303 of the heat desorption chamber device; on the other hand, the cool chamber 306 may be arranged to avoid heat damage to an operator when an operator inserts the sampling adsorber into the heat desorption chamber and/or onto a drive motor.

In an embodiment, in order to promote heat desorption, the heat chamber 303 includes: a temperature control device including a heater configured to heat the heat chamber 303 and a temperature sensor configured to measure a temperature within the heat chamber 303; and a heat insulation portion configured to isolate heat within the heat chamber 303 from dissipating to outside of the heat desorption chamber device. For example, the chamber bay of the heat desorption chamber device may be made of a stainless steel or copper or other metal that has a good thermal conduction efficiency and meanwhile, the thermal isolating disc 305 is made of a ceramic material to help isolate the heat chamber 303 from the cool chamber 306. In an embodiment, the heat chamber 303 may be wrapped by a heating film which may heat the heat chamber 303. A temperature sensor may be mounted on outside surface of the heat chamber 303, to measure the temperature in the heat chamber 303. Generally, the heat chamber 303 may be controlled at a temperature from 50 Celsius degrees to 300 Celsius degrees. In order to improve heating and heat preservation effects, the heat chamber 303 may be wrapped by a heat insulation cotton or other heat insulation layer/material. The heat insulation layer/material may increase work efficiency of the heat chamber and save energy, and further may avoid a user from heat damage by the heat chamber 303 of the heat desorption chamber device. In an embodiment, the heater may be a heating coil or resistance wire heater which surrounds the heat chamber 303 and may increase the temperature within the heat chamber 303.

Embodiments of the present disclosure further provide a sampling apparatus including the above sampling adsorber and the heat desorption chamber device.

The sampling adsorber may be inserted into the cool chamber 306 of the heat desorption chamber device through the open chamber second end such that the outer barrel first sealing ring 1035 on the outer circumferential surface of the outer barrel first end of the outer barrel 1001 of the sampling adsorber abuts against the isolating disc 305. According to the sampling apparatus of the embodiment, the sampling adsorber and the heat desorption chamber device may be conveniently separated from each other and assembled together such that the sampling adsorber may be used separately for sampling.

As shown in FIG. 4, the sampling adsorber is inserted into the heat desorption chamber device and the outer barrel first sealing ring 1035 seals between the outer peripheral surface of the left end of the outer barrel 1001 and the isolating disc 305 of the heat desorption chamber device such that the gas in a portion of the heat desorption chamber at the left side of the isolating disc 305 cannot enter the right portion of the heat desorption chamber through the gap between the sampling adsorber and the isolating disc 305.

As shown in FIG. 4, when the sampling adsorber is inserted into the cool chamber 306 of the heat desorption chamber device, the heating rod 308 of the heat desorption chamber device is in contact with and applies force to the adsorbent portion 102 of the sampling adsorber, such that the adsorbent portion 102 moves within the outer barrel 1001 until the sampling adsorber T-shaped head 107 is stopped by the second end of the sliding groove 109, thereby the sampling adsorber is in the second state. The core 1002 of the sampling adsorber is withstood by the heating rod 308 protruding rightwards from the baffle plate 304. In the embodiment, the sampling adsorber moves leftwards with the core being withstood by the heating rod 308, that is, the core 1002 moves rightwards relative to the outer barrel 1001 until the sampling adsorber T-shaped head 107 is stopped by the second end of the sliding groove 109.

When the sampling adsorber continues to move leftwards, that is, when the sampling adsorber is inserted into the heat chamber 303 of the heat desorption chamber device, the adsorbent portion 102 of the sampling adsorber is stopped from moving leftwards. In this stage, the core 1002 and the outer barrel 1001 move leftwards together. The adsorbent portion 102 applies force to the heating rod 308 such that the heating rod 308 together with the baffle plate 304 moves towards a left portion of the chamber body of the heat desorption chamber device until the heat desorption chamber device enters the third state. When the heat desorption chamber device is in the third state, the outer barrel first sealing ring 1035 on the outer peripheral surface of the outer barrel first end slides along the inner wall of the heat chamber 303 along the heat chamber 303 up to a position between the carrier gas inlet 301 and the carrier gas outlet 302.

As shown in FIG. 5, the baffle plate 304 is located at the left side of the carrier gas outlet 302 and the carrier gas may enter the heat desorption chamber through the carrier gas inlet; meanwhile, the carrier gas is blocked by the outer barrel first sealing ring 1035 from passing through a space between the outer barrel 1001 and the chamber body of the heat desorption chamber device, but is allowed to enter the adsorbent portion 102 of the sampling adsorber, then pass through the desorbed sample passage 110, is discharged from the outlet of the desorbed sample passage 110 and finally is discharged from the carrier gas outlet 302.

During desorption, the heating rod 308 may be used to directly increase the temperature of the adsorbent portion 102 of the sampling adsorber, promoting release of the sample that is adsorbed by the adsorbent portion 102. Meanwhile, the heat chamber 303 is heated by the temperature control device such that the temperature within the heat chamber 303 is maintained at a desired value and the sample that is adsorbed and concentrated in the adsorbent portion 102 and/or the sampling head 101 is desorbed and separated at an increased speed. In this case, the carrier gas enters from the carrier gas inlet 301, passes through the adsorbent portion 102 while carrying the sample away, and finally carries the sample to pass through the carrier gas outlet 302 to an analyzer apparatus such as an ion migration spectroscopy tool.

In an embodiment of the present disclosure, since the sampling head 101 made of silicon rubber and adsorbent at a room temperature during sampling, it is in favor of sampling and absorption of a sample. Meanwhile, during desorption, the heat desorption chamber may be controlled at a temperature range from 80 Celsius degrees to 300 Celsius degrees, so that the adsorbent that is inserted into the heat desorption chamber may be heated at an increased speed and the sample adsorbed in the adsorbent may be easy released or separated from the adsorbent. Further, the carrier gas that is, e.g., preheated may rapidly mix with the gas containing the separated sample such that the sample may be effectively carried by the carrier gas out of the heat desorption chamber, and then transferred to an analyzer apparatus, such as an ion migration spectroscopy/chromatography-ion migration spectroscopy tool for measurement.

In an embodiment, a heater may be provided within the baffle plate 304 to assist in increasing the temperature in the adsorbent portion 102.

In an embodiment, a stop piece 105/131 may be provided on the outer peripheral surface of the outer barrel 1001. The stop piece 105/131 is configured to, in the third state of the heat desorption chamber device, abut against the thermal isolating disc 305 of the heat desorption chamber device so as to stop the outer barrel 1001 of the sampling adsorber from moving towards the first end of the heat desorption chamber device. Provision of the stop piece 105/131 is advantageous because the stop piece 105/131 abutting against the isolating disc 305 indicates that the sampling adsorber is pushed in place and that the heat desorption chamber device is brought to the third state, so that a heat desorption may start. In addition, in an embodiment, the stop piece 105/131 may be used as a driven component, for example, a drive motor is provided to drive the stop piece 105/131 such that the sampling adsorber moves within the heat desorption chamber. In an embodiment, an outer barrel second sealing ring 1036 is used to provide a seal between the outer barrel and the chamber body. In an embodiment, when the stop piece 105/131 abuts the isolating disc 305, the outer barrel second sealing ring 1036 contacts the isolating disc 305 to provide a seal between the outer barrel and the isolating disc 305.

In an embodiment, the sampling adsorber includes a slidable collar 106 surrounding the outer peripheral surface of the outer barrel 1001. The slidable collar 106 may fit in a notch 307 in the second end of the chamber body of the heat desorption chamber device while allowing the outer barrel 1001 to move within the heat desorption chamber device.

In the present disclosure, a plurality of sealing rings are provided and may be made of high-temperature resistant fluoroelastomer. These rings may be replaceable.

In embodiments of the present disclosure, the adsorbent in the adsorbent portion 102 may be adapted to be active carbon or Tenax-TA absorbent resin.

In embodiments of the present disclosure, the pump 201 may be used and may be chosen as a type of KNF NMP 015B pump.

Although some embodiments according to a general concept of the present disclosure have been revealed and described, it is understood that these embodiments may be modified without departing the principle and spirits of the present disclosure. The scope of the present disclosure is defined by the claims and their equivalents.

1. A sampling adsorber comprising:
an outer barrel, which comprises an outer barrel first end and an outer barrel second end; and
a core located in the outer barrel, the core having a core first end and a core second end, the outer barrel first end and the core first end being located at a same side of the sampling adsorber,
wherein the core comprises an adsorbent portion configured to adsorb a sample and a core body portion, the adsorbent portion connected to the core body portion, and
wherein sizes of the outer barrel and the core are formed such that a gap is provided between the outer barrel and the core to allow external gas to enter the gap through the adsorbent portion and to subsequently be discharged from a downstream portion of the gap.

2. The sampling adsorber as claimed in claim 1, wherein the outer barrel comprises a bypass passage including a bypass passage inlet and a bypass passage outlet that are separated from each other spatially, the bypass passage inlet being closer to the outer barrel first end than the bypass passage outlet; and
the sampling adsorber further includes an adsorber first inner sealing ring and an adsorber second inner sealing ring that are located between the core and the outer barrel and located at an outer peripheral surface of the core, the adsorber first inner sealing ring and the adsorber second inner sealing ring spaced apart from each other and configured to allow the core to move within the outer barrel while keeping a seal between the core and the outer barrel, and arranged such that, in a first state of the sampling adsorber, the adsorber first inner sealing ring and the adsorber second inner sealing ring are located between the bypass passage inlet and the bypass passage outlet, the adsorber first inner sealing ring is close to the bypass passage inlet and the adsorber second inner sealing ring is close to the bypass passage outlet, such that gas entering the gap through the adsorbent portion is blocked by the adsorber first inner sealing ring and flows into the bypass passage inlet, out of the bypass passage outlet and enters the downstream portion of the gap.

3. The sampling adsorber as claimed in claim 2, wherein the sampling adsorber is brought into a second state by movement of the core relative to the outer barrel, and in the second state of the sampling adsorber, the adsorber first inner sealing ring is located between the bypass passage inlet and the bypass passage outlet and the adsorber second inner sealing ring is located at a side of the bypass passage outlet away from the outer barrel first end, such that gas flowing out of the bypass passage outlet is blocked by the adsorber second inner sealing ring from entering the downstream portion of the gap.

4. The sampling adsorber as claimed in claim 3, wherein the core body portion second end of the core body portion opposite to the core body portion first end comprises sampling adsorber T-shaped head at its outer surface, and the outer barrel comprises a sliding groove on an inner side of the outer barrel second end such that the sampling adsorber T-shaped head is slidable in the sliding groove and a movement travel of the sampling adsorber T-shaped head is defined by the sliding groove, and
under the first state of the sampling adsorber, the sampling adsorber T-shaped head contacts a first end of the sliding groove, and under the second state of the sampling adsorber, the sampling adsorber T-shaped head contacts a second end of the sliding groove, the second end of the sliding groove being closer to the core body portion second end than the first end of the sliding groove.

5. The sampling adsorber as claimed in claim 1, wherein the outer barrel comprises a desorbed sample passage that is configured to allow gas to flow from the adsorbent portion to outside of the outer barrel; and
the sampling adsorber further comprises an adsorber first inner sealing ring and an adsorber second inner sealing ring that are located between the core and the outer barrel and located at an outer peripheral surface of the core, the adsorber first inner sealing ring and the adsorber second inner sealing ring spaced apart from each other and configured to allow the core to move within the outer barrel while keeping a seal between the core and the outer barrel, and arranged such that, in a first state of the sampling adsorber, the inlet of the desorbed sample passage is located between the adsorber first inner sealing ring and the adsorber second inner sealing ring and gas is blocked by the adsorber first inner sealing ring and the adsorber second inner sealing ring from entering the desorbed sample passage.

6. The sampling adsorber as claimed in claim 5, wherein the sampling adsorber is brought into a second state by movement of the core relative to the outer barrel, in which second state the adsorber first inner sealing ring and the adsorber second inner sealing ring are located at a side of the inlet of the desorbed sample passage away from the outer barrel first end, such that gas enters the desorbed sample passage only through the gap and is discharged from the outer barrel through the desorbed sample passage.

7. The sampling adsorber as claimed in claim 1, wherein the core body portion comprises an adsorber sampling passage having an inlet in communication with the gap and an outlet exposed to outside of the outer barrel.

8. The sampling adsorber as claimed in claim 1, further comprising an adsorber third sealing ring located at an outer peripheral surface of the core first end, the adsorber third sealing ring configured to allow the adsorber to move relative to the outer barrel while keeping a seal between the adsorber and the outer barrel.

9. The sampling adsorber as claimed in claim 1, further comprising a sampling head removably mounted to an end of the outer barrel, the sampling head configured to scrape an object to be inspected such that the sample is released from the object to be inspected.

10. The sampling adsorber as claimed in claim 9, wherein the sampling head is made of silicon rubber so as to adhere the sample to be inspected; and/or the sampling head has an adsorbent therein so as to adsorb the sample to be inspected.

11. The sampling adsorber as claimed in claim 1, wherein the adsorbent portion has screen mesh structures at both ends thereof to filter large size particles and the screen mesh structures are removably coupled with the adsorbent portion so as to fix an adsorbent in the adsorbent portion.

12. A heat desorption chamber device comprising:
a chamber body, the chamber body defining a heat desorption chamber, wherein the chamber body has a chamber first end and a chamber second end that is opposite to the chamber first end and is open, and the chamber body comprises a heat chamber and a cool chamber that are connected to each other by a thermal isolating disc, wherein a sampling adsorber as claimed in claim 1 is insertable into the cool chamber of the chamber body through the chamber second end;
a baffle plate and a baffle plate sealing ring between the baffle plate and the chamber body, the baffle plate sealing ring configured to allow the baffle plate to be movable within the heat chamber while keeping a seal between the baffle plate and the chamber body; and
a carrier gas inlet and a carrier gas outlet such that, in a particular state of the heat desorption chamber device, the baffle plate is located at a side of the carrier gas outlet away from the chamber first end, so that a carrier gas is allowed to enter the heat desorption chamber through the carrier gas inlet and is discharged from the carrier gas outlet.

13. The heat desorption chamber device as claimed in claim 12, wherein the baffle plate is connected to the chamber first end by a spring, wherein the spring is configured such that the baffle plate is kept by the spring, under no external force, at a side of the carrier gas outlet away from the chamber first end and is allowed to move towards the chamber first end by pressing the spring under an external force, so that the baffle plate sealing ring is located at a side of the carrier gas inlet close to the chamber first end.

14. The heat desorption chamber device as claimed in claim 12, further comprising a heating rod mounted to the baffle plate, the heating rod protruding from the baffle plate towards the chamber second end.

15. The heat desorption chamber device as claimed in claim 12, further comprising:
a temperature control device which comprises a heater configured to heat the heat chamber and a temperature sensor configured to measure a temperature within the heat chamber; and
a heat insulation portion configured to isolate heat within the heat chamber from dissipating to outside of the heat desorption chamber device.

16. A sampling apparatus comprising:
the sampling adsorber as claimed in claim 1; and
a heat desorption chamber device comprising a chamber body, the chamber body defining a heat desorption chamber, wherein the chamber body has a chamber first end and a chamber second end that is opposite to the chamber first end and is open, and the chamber body comprises a heat chamber and a cool chamber that are connected to each other by a thermal isolating disc,
wherein the sampling adsorber is insertable into the cool chamber of the heat desorption chamber device through the chamber second end, such that the outer barrel first end of the outer barrel of the sampling adsorber abuts against the thermal isolating disc via an outer barrel first sealing ring at an outer peripheral surface of the outer barrel first end.

17. The sampling apparatus as claimed in claim 16, wherein, in a state where the sampling adsorber is inserted into the cool chamber, a heating rod of the heat desorption chamber device contacts and applies force onto the adsorbent portion of the sampling adsorber, such that the adsorbent portion moves within the outer barrel until a sampling adsorber head is stopped by an end of a sliding groove.

18. The sampling apparatus as claimed in claim 17, wherein the sampling adsorber is insertable into the heat chamber such that the adsorbent portion of the sampling adsorber applies force onto the heating rod to move the heating rod towards the chamber first end; and
wherein the outer barrel first sealing ring slides within the heat chamber along an inner wall of the heat chamber up to a position between a carrier gas inlet and a carrier gas outlet.

19. The sampling apparatus as claimed in claim 18, wherein a stop piece, located at an outer peripheral surface of the outer barrel, is configured to, in a particular state of the heat desorption chamber device, abut against the thermal isolating disc of the heat desorption chamber device so as to stop the outer barrel of the sampling adsorber from moving towards the chamber first end.

20. The sampling apparatus as claimed in claim 16, wherein the sampling adsorber comprises a slidable collar surrounding the outer peripheral surface of the outer barrel, the slidable collar being fittable in a notch at the chamber second end while allowing the outer barrel to move within the heat desorption chamber device.
